(19) United States
(12) Patent Application Publication
(10) Pub. No.: US 2026/0318763 A1
(43) Pub. Date: Oct. 15, 2026

(54) SENSOR DEVICE, TORQUE SENSOR DEVICE, AND MAGNETIC SENSOR MODULE

(71) Applicant: DENSO CORPORATION, Kariya-city (JP)

(72) Inventors: Takuma ESAKA, Kariya-city (JP); Kazuhiro YOSHINO, Kariya-city (JP); Norihito YOSHIDA, Kariya-city (JP); Hiroki SHIMADA, Kariya-city (JP)

(21) Appl. No.: 19/563,302

(22) Filed: Mar. 11, 2026

Related U.S. Application Data
(63) Continuation of application No. PCT/JP2024/028132, filed on Aug. 6, 2024.

(30) Foreign Application Priority Data
Sep. 13, 2023 (JP) 2023-148627

(51) Int. Cl. G01L 5/22; G01D 11/24; G01L 3/10

(52) U.S. Cl. CPC G01L 5/221; G01D 11/245; G01L 3/104

(57) ABSTRACT

A sensor device includes a sensor body, a sensor housing, a connector housing and a flange. The sensor body senses a change in a physical quantity, and the sensor housing houses at least a part of the sensor body. The connector housing is provided with a detection element that outputs a signal according to a change in a physical quantity, and the portion where the detection element is provided is inserted inside the sensor housing. The flange extends outward from the connector housing, and a joint surface facing the sensor housing is joined to the sensor housing. The joint surface of the flange is inclined with respect to an imaginary plane perpendicular to the direction in which the portion of the connector housing in which the detection element is provided is inserted into the sensor housing.

### CROSS REFERENCE TO RELATED APPLICATIONS

The present application is a continuation application of International Patent Application No. PCT/JP2024/028132 filed on Aug. 6, 2024, which designated the U.S. and claims the benefit of priority from Japanese Patent Application No. 2023-148627 filed on Sep. 13, 2023, the entire disclosure of the above application is incorporated herein by reference.

### TECHNICAL FIELD

The present disclosure relates to a sensor device, a torque sensor device, and a magnetic sensor module mounted on a vehicle.

### BACKGROUND

A magnetic detection device (hereinafter referred to as a magnetic sensor module) constitutes a part of a torque sensor device used in an electric power steering system.

### SUMMARY

An object of the present disclosure is to provide a sensor device, a torque sensor device, and a magnetic sensor module that allow an external connector to be attached and detached and that can be made smaller in size.

According to one aspect of the present disclosure, a sensor device mounted on a vehicle includes:
a sensor body that senses a change in physical quantity,
a sensor housing that accommodates at least a portion of the sensor body,
a connector housing having a detection element that outputs a signal corresponding to a change in the physical quantity, a portion of the connector housing where the detection element is provided being inserted into the sensor housing, and
a flange extending outward from the connector housing, the flange having a joint surface facing the sensor housing, the joint surface being joined to the sensor housing.

The joint surface is inclined with respect to an imaginary plane perpendicular to a direction in which a portion of the connector housing having the detection element is inserted into the sensor housing.

According to another aspect of the present disclosure, a torque sensor device for detecting a torque acting on a shaft around an axis includes:
a torsion bar that coaxially connects a first shaft and a second shaft that constitute the shaft and converts torque acting between the first shaft and the second shaft into a torsional displacement,
a multi-pole magnet fixed to one end side of either the first shaft or the torsion bar, with N poles and S poles alternately arranged in a circumferential direction,
a yoke fixed to the other end of the second shaft or the torsion bar outside the multi-pole magnet and forming a magnetic circuit within a magnetic field of the multi-pole magnet,
a first magnetic flux guide member and a second magnetic flux guide member provided outside the yoke and guiding a magnetic flux flowing through the yoke,
a sensor housing that fixes the first magnetic flux guide member and the second magnetic flux guide member,
a magnetic detection element that outputs a signal corresponding to the density of magnetic flux passing through a portion where the first magnetic flux guide member and the second magnetic flux guide member are adjacent to each other,
a connector housing in which the magnetic detection element is provided, a portion of the connector housing where the magnetic detection element is provided being inserted into the sensor housing, and
a flange extending outward from the connector housing, the flange having a joint surface facing the sensor housing, the joint surface being joined to the sensor housing.

The joint surface is inclined with respect to an imaginary plane perpendicular to a direction in which a portion of the connector housing having the detection element is inserted into the sensor housing.

According to yet another aspect of the present disclosure, a magnetic sensor module for detecting a magnetic flux flowing through a yoke, includes:
a first magnetic flux guide member and a second magnetic flux guide member that guides magnetic flux flowing through the yoke,
a sensor housing that houses the first magnetic flux guide member and the second magnetic flux guide member,
a magnetic detection element that outputs a signal corresponding to the density of magnetic flux passing through a portion where the first magnetic flux guide member and the second magnetic flux guide member are adjacent to each other,
a connector housing in which the magnetic detection element is provided, a portion of the connector housing where the magnetic detection element is provided being inserted into the sensor housing, and
a flange extending outward from the connector housing, the flange having a joint surface facing the sensor housing, the joint surface being joined to the sensor housing.

The joint surface is inclined with respect to an imaginary plane perpendicular to a direction in which a portion of the connector housing having the detection element is inserted into the sensor housing.

### BRIEF DESCRIPTION OF THE DRAWINGS

FIG. 1 is a schematic diagram of an electric power steering system equipped with a torque sensor device according to a first embodiment;

FIG. 2 is an exploded perspective view of the torque sensor device according to the first embodiment;

FIG. 3 is a perspective view of a multi-pole magnet and a yoke provided in the torque sensor device;

FIG. 4 is a side view showing a relative rotation state between the multi-pole magnet and the yoke;

FIG. 5 is a side view showing the relative rotation state between the multi-pole magnet and the yoke;

FIG. 6 is a side view showing a relative rotation state between the multi-pole magnet and the yoke;

FIG. 7 is an exploded perspective view of a magnetic sensor module used in the torque sensor device according to the first embodiment;

FIG. 8 is a side view of the magnetic sensor module used in the torque sensor device according to the first embodiment;

FIG. 9 is an explanatory diagram for explaining how the flange and the sensor housing are laser welded together;

FIG. 10 is an explanatory diagram illustrating a state in which the flange and the sensor housing are laser-welded together in a cross section taken along a line X-X in FIG. 9;

FIG. 11 is a side view showing a state in which the magnetic sensor module is mounted in a mounting space within a housing of the electric power steering system;

FIG. 12 is a side view showing a state in which the magnetic sensor module of a first comparative example is mounted in a mounting space within the housing of the electric power steering system;

FIG. 13 is an exploded perspective view of the torque sensor device according to a second embodiment;

FIG. 14 is a cross-sectional view of a multi-pole magnet, a yoke, and a magnetic flux guide member included in a torque sensor device according to the second embodiment;

FIG. 15 is a cross-sectional view of a torque sensor device according to the second embodiment;

FIG. 16 is an exploded perspective view of a magnetic sensor module used in the torque sensor device according to the second embodiment;

FIG. 17 is a cross-sectional view of a magnetic sensor module used in a torque sensor device according to a third embodiment;

FIG. 18 is a schematic diagram of a magnetic sensor module of a second comparative example; and

FIG. 19 is a schematic diagram of a magnetic sensor module according to a third embodiment.

### DETAILED DESCRIPTION

In an assumable example, the magnetic detection device (hereinafter referred to as a magnetic sensor module) constitutes a part of a torque sensor device used in an electric power steering system. This magnetic sensor module is configured by joining a magnetic flux collector holder that holds a first magnetic flux collector and a second magnetic flux collector, and a board holder that holds a circuit board on which a magnetic detection element is mounted. A wiring electrically connected to the board is fixed to the circuit board holder. A signal output from the magnetic detection element is transmitted from the circuit board via wiring to an electronic control unit (hereinafter referred to as “ECU”) on the vehicle side. ECU is an abbreviation of Electronic Control Unit.

However, in the magnetic sensor module, the wiring is fixed to the circuit board holder. Therefore, when a distance between the magnetic sensor module and the ECU differs depending on the vehicle model in which the magnetic sensor module is installed, the specifications of the circuit board holder must be changed, which poses a problem of increased design and manufacturing costs.

In order to address these issues, it is conceivable to configure the external connector to be detachable from the circuit board holder provided in the magnetic sensor module. However, in this case, if an opening is provided in the circuit board holder to allow the external connector to be attached and detached, the circuit board holder will become larger. Furthermore, the magnetic sensor module has a configuration in which a flange provided on an outer periphery of the circuit board holder is joined to the magnetic flux collector holder, so that an outer periphery of the flange also becomes larger as the circuit board holder becomes larger. This makes it difficult to mount the magnetic sensor module in a mounting space within the housing of the electric power steering system.

An object of the present disclosure is to provide a sensor device, a torque sensor device, and a magnetic sensor module that allow an external connector to be attached and detached and that can be made smaller in size.

According to one aspect of the present disclosure, a sensor device mounted on a vehicle includes:
a sensor body that senses a change in physical quantity,
a sensor housing that accommodates at least a portion of the sensor body,
a connector housing having a detection element that outputs a signal corresponding to a change in the physical quantity, a portion of the connector housing where the detection element is provided being inserted into the sensor housing, and
a flange extending outward from the connector housing, the flange having a joint surface facing the sensor housing, the joint surface being joined to the sensor housing.

The joint surface is inclined with respect to an imaginary plane perpendicular to a direction in which a portion of the connector housing having the detection element is inserted into the sensor housing.

According to this configuration, even if a distance between the sensor device and an ECU differs depending on a vehicle model, the sensor device can be adapted by simply changing a length of a wiring provided to an external connector. Therefore, there is no need to change the specifications of the sensor device depending on the vehicle model, and design and manufacturing costs can be reduced.

Furthermore, in the sensor device, the joint surface of the flange is shaped to be inclined with respect to an imaginary plane perpendicular to the direction in which the portion of the connector housing where the detection element is provided is inserted into the sensor housing. According to this configuration, while ensuring an area of the joint surface that guarantees the joint strength between the flange and the connector housing, as well as the area of the opening of the connector housing into which the external connector is inserted, the sensor device can be made more compact. Therefore, the sensor device can be mounted in a small mounting space within the housing of the vehicle side system.

The joint surface of the flange is inclined to a greater extent than the inclination due to manufacturing tolerances when the flange is configured parallel to an imaginary plane.

According to another aspect of the present disclosure, a torque sensor device for detecting a torque acting on a shaft around an axis includes:
a torsion bar that coaxially connects a first shaft and a second shaft that constitute the shaft and converts torque acting between the first shaft and the second shaft into a torsional displacement,
a multi-pole magnet fixed to one end side of either the first shaft or the torsion bar, with N poles and S poles alternately arranged in a circumferential direction,
a yoke fixed to the other end of the second shaft or the torsion bar outside the multi-pole magnet and forming a magnetic circuit within a magnetic field of the multi-pole magnet,
a first magnetic flux guide member and a second magnetic flux guide member provided outside the yoke and guiding a magnetic flux flowing through the yoke,
a sensor housing that fixes the first magnetic flux guide member and the second magnetic flux guide member,
a magnetic detection element that outputs a signal corresponding to the density of magnetic flux passing through a portion where the first magnetic flux guide member and the second magnetic flux guide member are adjacent to each other,
a connector housing in which the magnetic detection element is provided, a portion of the connector housing where the magnetic detection element is provided being inserted into the sensor housing, and
a flange extending outward from the connector housing, the flange having a joint surface facing the sensor housing, the joint surface being joined to the sensor housing.

The joint surface is inclined with respect to an imaginary plane perpendicular to a direction in which a portion of the connector housing having the detection element is inserted into the sensor housing.

According to this configuration, the torque sensor device has the same effects as the sensor device described above.

According to yet another aspect of the present disclosure, a magnetic sensor module for detecting a magnetic flux flowing through a yoke, includes:
a first magnetic flux guide member and a second magnetic flux guide member that guides magnetic flux flowing through the yoke,
a sensor housing that houses the first magnetic flux guide member and the second magnetic flux guide member,
a magnetic detection element that outputs a signal corresponding to the density of magnetic flux passing through a portion where the first magnetic flux guide member and the second magnetic flux guide member are adjacent to each other,
a connector housing in which the magnetic detection element is provided, a portion of the connector housing where the magnetic detection element is provided being inserted into the sensor housing, and
a flange extending outward from the connector housing, the flange having a joint surface facing the sensor housing, the joint surface being joined to the sensor housing.

The joint surface is inclined with respect to an imaginary plane perpendicular to a direction in which a portion of the connector housing having the detection element is inserted into the sensor housing.

According to this configuration, the magnetic sensor module has the same effects as the above-mentioned sensor device.

Embodiments of the present disclosure will now be described with reference to the drawings. Parts that are identical or equivalent to each other in the following embodiments are assigned the same reference numerals and will not be described.

### First Embodiment

A sensor device according to a first embodiment will be described. The sensor device of the first embodiment is a torque sensor device 10 that detects torque acting on a shaft around the axis. The torque sensor device 10 is applied to an electric power steering system 1 mounted on a vehicle.

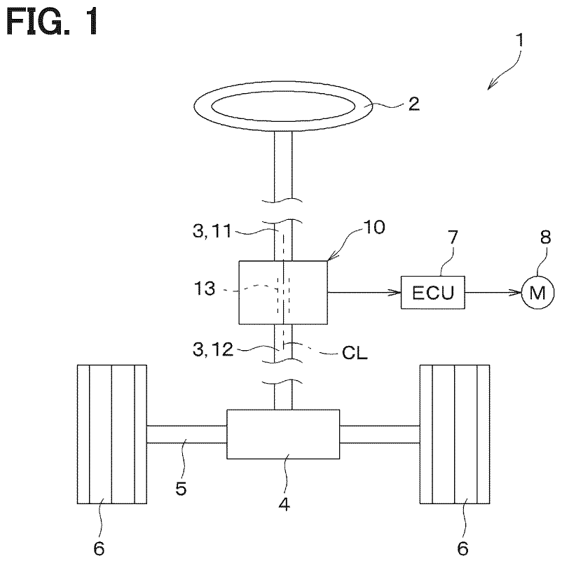

First, the schematic configuration of the electric power steering system 1 will be described with reference to FIG. 1. The electric power steering system 1 may be of a column assist type or a rack assist type. A steering shaft 3 is connected to a steering wheel 2. The steering shaft 3 is provided with a torque sensor device 10 that detects the torque acting on the steering shaft 3 around its axis, i.e., the steering torque. A steering gear mechanism 4 is provided at a tip of the steering shaft 3. The steering gear mechanism 4 is connected to a pair of wheels 6 via a link mechanism 5.

The torque sensor device 10 is provided between an input shaft 11 and an output shaft 12 that constitute the steering shaft 3, and detects the steering torque and outputs the detected torque to the ECU 7. The ECU 7 controls the driving force of the electric motor 8 in accordance with the steering torque. The driving force of the electric motor 8 is transmitted to the output shaft 12 of the steering shaft 3 or the steering gear mechanism 4. As a result, the electric power steering system 1 assists the steering force for changing the direction of the wheels 6.

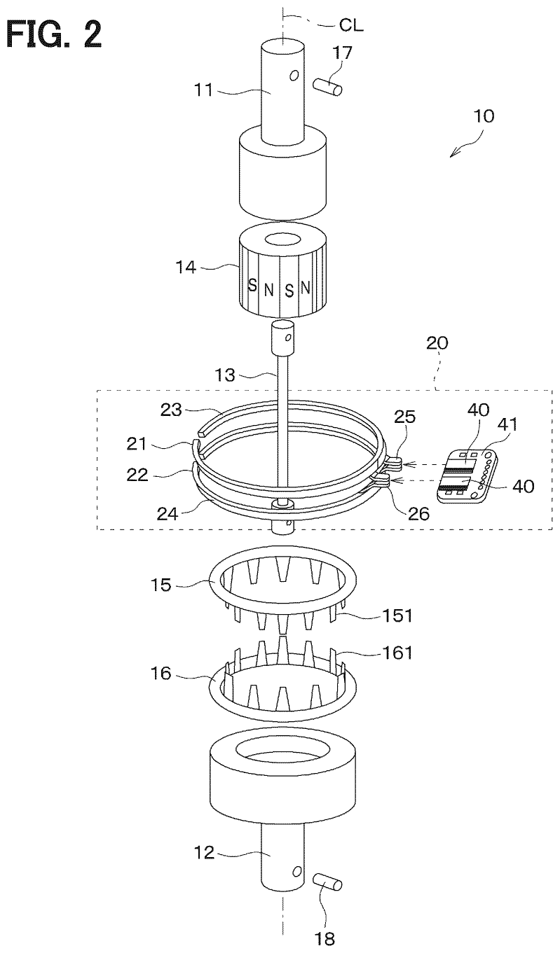

Next, the overall configuration of the torque sensor device 10 will be described with reference to FIGS. 2 to 8.

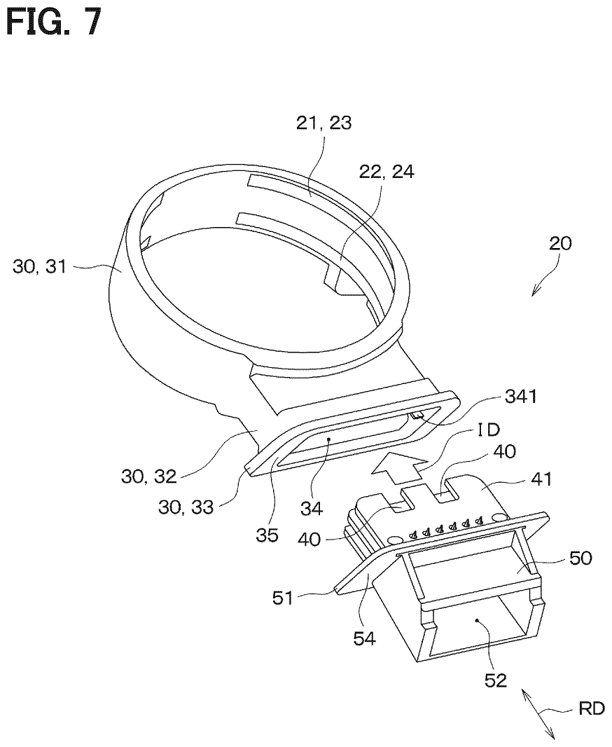

As shown in FIG. 2, the torque sensor device 10 includes a torsion bar 13, a multi-pole magnet 14, yokes 15 and 16, and a magnetic sensor module 20. As shown in FIGS. 2 and 7, the magnetic sensor module 20 includes a first magnetic flux guide member 21, a second magnetic flux guide member 22, a sensor housing 30, a magnetic detection element 40, a connector housing 50, and a flange 51.

In the following description, a radial direction of an imaginary circle drawn on a plane perpendicular to the central axis CL of the steering shaft 3 with the central axis CL as its center is referred to as the “radial direction,” a circumferential direction of the imaginary circle is referred to as the “circumferential direction,” and a direction in which the central axis CL extends is referred to as the “axial direction.”

As shown in FIG. 2, one end of the torsion bar 13 is fixed to the input shaft 11, which serves as the “first shaft,” by a first fixing pin 17, and the other end is fixed to the output shaft 12, which serves as the “second shaft,” by a second fixing pin 18. As a result, the torsion bar 13 coaxially connects the input shaft 11 and the output shaft 12 on the central axis CL. The torsion bar 13 is a rod-shaped elastic member, and the amount of torsional displacement thereof changes in accordance with the steering torque acting between the input shaft 11 and the output shaft 12. That is, the torsion bar 13 converts the steering torque into a torsional displacement. The central axis CL of the torsion bar 13 and the central axis CL of the steering shaft 3 coincide with each other.

The multi-pole magnet 14 is a permanent magnet in which north and south poles are alternately arranged in the circumferential direction, and is fixed to the input shaft 11. The multi-pole magnet 14 may be fixed to one end of the torsion bar 13. The multi-pole magnet 14 has, for example, eight north poles and eight south poles arranged at intervals of 22.5°.

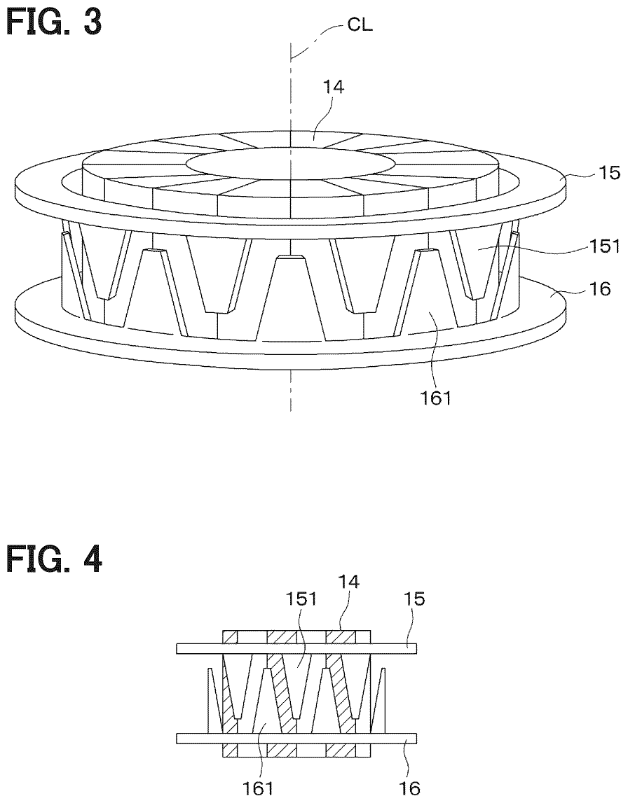

The first yoke 15 and the second yoke 16 (hereinafter referred to as “a pair of yokes 15, 16”) are formed in an annular shape from a soft magnetic material, are held by a holding member (not shown) radially outside the multi-pole magnet 14, and are fixed to the output shaft 12. The pair of yokes 15 and 16 may be fixed to the other end of the torsion bar 13. As shown in FIG. 3, the pair of yokes 15 and 16 face each other in the axial direction with a gap therebetween. The pair of yokes 15 and 16 each have claws 151 and 161, the number of which is equal to the number of north poles or south poles of the multi-pole magnet 14, spaced equally apart in the circumferential direction. The claws 151 of the first yoke 15 and the claws 161 of the second yoke 16 are arranged alternately and offset in the circumferential direction. In this way, the pair of yokes 15 and 16 form a magnetic circuit within the magnetic field generated by the multi-pole magnet 14.

When the amount of torsional displacement of the torsion bar 13 changes, the multi-pole magnet 14 and the pair of yokes 15 and 16 rotate relative to each other, and the flow of magnetic flux in the magnetic circuit formed by the pair of yokes 15 and 16 changes accordingly. FIGS. 3 and 4 show a state in which no torsional torque is acting on the torsion bar 13. In FIGS. 4 to 6, for the sake of explanation, the north pole of the multi-pole magnet 14 is hatched, although not in cross section, and the south pole is not hatched. In the state shown in FIGS. 3 and 4, the center positions in the circumferential direction of the claws 151 and 161 of the pair of yokes 15 and 16 and a boundary between the north and south poles of the multi-pole magnet 14 are positioned so as to overlap in the radial direction. At this time, no magnetic flux flows between the first yoke 15 and the second yoke 16.

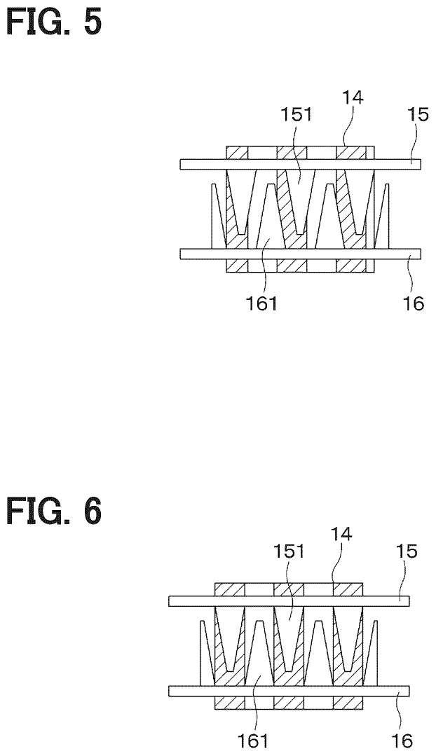

FIGS. 5 and 6 show a state in which the torsional torque acting on the torsion bar 13 gradually increases. Therefore, the amount of torsional displacement of the torsion bar 13 gradually increases from the state shown in FIG. 4 to the state shown in FIG. 6 via the state shown in FIG. 5. As a result, the area where the north pole of the multi-pole magnet 14 and the claw 151 of the first yoke 15 overlap radially gradually increases, and the area where the south pole of the multi-pole magnet 14 and the claw 161 of the second yoke 16 overlap radially gradually increases. Therefore, the influence of the north pole of the multi-pole magnet 14 on the first yoke 15 gradually increases, and the influence of the south pole of the multi-pole magnet 14 on the second yoke 16 also gradually increases. Therefore, the density of the magnetic flux flowing between the first yoke 15 and the second yoke 16 gradually increases.

As shown in FIGS. 2 and 7, the first magnetic flux guide member 21 and the second magnetic flux guide member 22 (hereinafter referred to as the “pair of magnetic flux guide members 21, 22”) are made of a soft magnetic material. The first magnetic flux guide member 21 is provided radially outward of the first yoke 15 in the axial direction, and the second magnetic flux guide member 22 is provided radially outward of the second yoke 16 in the axial direction. The pair of magnetic flux guide members 21, 22 each have a magnetic flux collector 23, 24 formed in an annular or arc shape radially outside the pair of yokes 15, 16, and an extension portion 25, 26 extending radially outward from the magnetic flux collector 23, 24. In the first embodiment, the magnetic flux collectors 23 and 24 surround most of the radially outer sides of the pair of yokes 15 and 16. The first extension portion 25 and the second extension portion 26 are the locations where the first magnetic flux guide member 21 and the second magnetic flux guide member 22 are adjacent to each other. Therefore, the distance between the first extension portion 25 and the second extension portion 26 is smaller than the distance between the first magnetic flux collector 23 and the second magnetic flux collector 24. Therefore, the magnetic flux guided from the pair of yokes 15 and 16 to the magnetic flux collectors 23 and 24 of the pair of magnetic flux guide members 21 and 22 flows through the gap between the first extension portion 25 and the second extension portion 26.

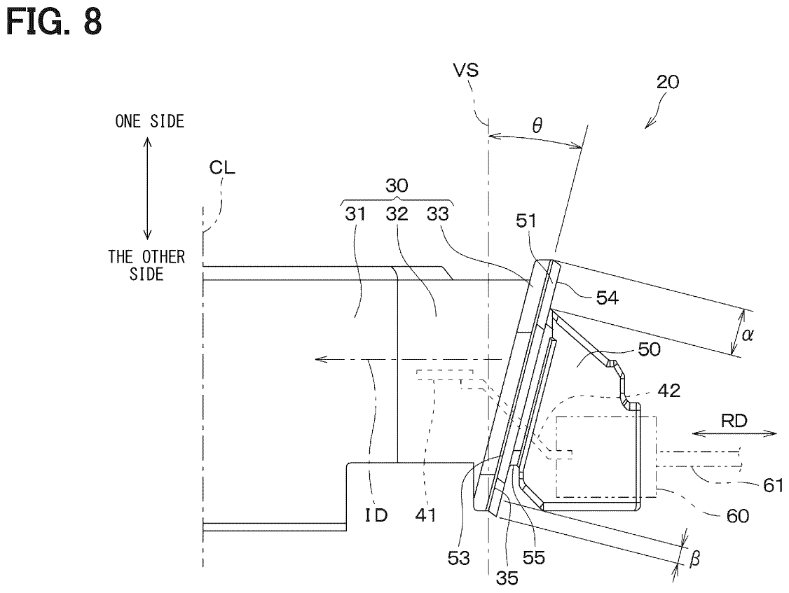

As shown in FIGS. 7 and 8, the pair of magnetic flux guide members 21 and 22 are housed in the sensor housing 30. The sensor housing 30 has a sensor housing main body 31 formed in a cylindrical shape, a sensor housing extension portion 32 extending from the sensor housing main body 31 toward the connector housing 50, and a sensor housing side flange 33 extending outward from the sensor housing extension portion 32. The central axis CL of the inner peripheral surface of the sensor housing main body 31 (hereinafter referred to as the “central axis CL of the sensor housing 30 ”) shown in FIG. 8 coincides with the central axis CL of the torsion bar 13. The magnetic flux collectors 23 and 24 of the pair of magnetic flux guide members 21 and 22 are fixed to radially inner portions of the sensor housing main body 31. The extension portions 25 and 26 of the pair of magnetic flux guide members 21 and 22 are fixed to the inside of the sensor housing extension portion 32.

As indicated by an arrow ID in FIG. 7, the magnetic detection element 40 mounted on a circuit board 41 together with a part of the connector housing 50 is inserted into the opening 34 of the sensor housing extension portion 32. In the following description, a direction in which the magnetic detection element 40 mounted on the circuit board 41 together with a part of the connector housing 50 is inserted into the opening 34 of the sensor housing extension portion 32 is referred to as the “element insertion direction ID.” A guide 341 is provided inside the sensor housing extension portion 32 to guide the circuit board 41 and other components when they are inserted. The guide 341 extends parallel to the direction in which the magnetic detection element 40 and the circuit board 41 are inserted into the connector housing 50 (i.e., the element insertion direction ID). Therefore, when the torque sensor device 10 and the magnetic sensor module 20 are in their completed state, the element insertion direction ID can be confirmed as the in-plane direction of the circuit board 41, the extension direction of the guide 341, or the extension direction of the axis of the sensor housing extension portion 32 formed in a rectangular cylindrical shape. Alternatively, as will be described later, the element insertion direction ID can be confirmed as the direction in which the magnetic detection element 40 is inserted between the first extension portion 25 and the second extension portion 26. The sensor housing side flange 33 is provided on the entire outer periphery of the opening 34 of the sensor housing extension portion 32. The flange 51 is joined to the surface 35 of the sensor housing side flange 33 on the flange 51 side.

The magnetic detection element 40 is mounted on the circuit board 41 and is disposed between the first extension portion 25 and the second extension portion 26 in a state where it is inserted into the opening 34 of the sensor housing extension portion 32. The magnetic detection element 40 is configured as an IC package in which, for example, a Hall element or a magnetoresistive element is resin-molded. The magnetic detection element 40 outputs an electric signal according to the density of magnetic flux passing through the gap between the first extension portion 25 and the second extension portion 26, which are adjacent portions of the pair of magnetic flux guide members 21, 22. In order to ensure redundancy or detection accuracy in torque detection, a plurality of magnetic detection elements 40 are mounted on the circuit board 41.

The connector housing 50 and the flange 51 are integrally formed by resin injection molding. The connector housing 50 is provided with the circuit board 41 on which the magnetic detection element 40 is mounted, and the terminal 42 electrically connected to the magnetic detection element 40. The connector housing 50 is provided with a cylindrical connector opening 52 to which an external connector 60 can be attached and detached. In FIG. 8, the external connector 60 inserted into the connector opening 52 and the wiring 61 extending from the external connector 60 are indicated by two-dot chain lines. In the following description, the direction in which the external connector 60 is attached to or detached from the connector opening 52 is referred to as the “external connector attachment/detachment direction RD.” In FIG. 8, the external connector attachment/detachment direction RD is indicated by a double-headed arrow. In the present embodiment, the element insertion direction ID and the external connector attachment/detachment direction RD are parallel to each other. In the present embodiment, the element insertion direction ID and the external connector attachment/detachment direction RD are perpendicular to the central axis CL of the sensor housing 30.

FIG. 8 is a side view of the magnetic sensor module 20 viewed from a direction perpendicular to the direction in which the central axis CL of the sensor housing 30 extends, and perpendicular to the element insertion direction ID and the external connector attachment/detachment direction RD. In the following description, the direction in which the central axis CL of the sensor housing 30 extends is referred to as the “axial direction of the sensor housing 30,” the upper side of FIG. 8 is referred to as “one axial side of the sensor housing 30,” and the lower side of FIG. 8 is referred to as “the other axial side of the sensor housing 30.”

As shown in FIGS. 7 and 8, the flange 51 extends outward from the connector housing 50. The flange 51 extends outward from the entire periphery of a surface of the connector housing 50 that faces in a direction intersecting the element insertion direction ID and the external connector attachment/detachment direction RD. The flange 51 is formed in a plate shape and is inclined with respect to an imaginary plane VS perpendicular to the element insertion direction ID. It can also be said that the flange 51 is inclined with respect to an imaginary plane VS perpendicular to the circuit board 41. It can also be said that the flange 51 is inclined with respect to the imaginary plane VS parallel to the central axis CL of the torsion bar 13 or the sensor housing 30. It can also be said that the flange 51 is inclined with respect to the imaginary plane VS perpendicular to the external connector attachment/detachment direction RD. It can also be said that the flange 51 is inclined with respect to the imaginary plane VS perpendicular to the axis of the sensor housing extension portion 32 formed in a rectangular cylindrical shape.

The surface of the flange 51 facing the sensor housing 30 is called a joint surface 53. The joint surface 53 of the flange 51 is the surface that is joined to the sensor housing side flange 33. The surface of the flange 51 facing away from the joint surface 53 is called a non-joint surface 54. The joint surface 53 and the non-joint surface 54 of the flange 51 are formed parallel to each other. Both the joint surface 53 and the non-joint surface 54 of the flange 51 are inclined with respect to the imaginary plane VS.

As shown in FIG. 8, an inclination angle 0 of the joint surface 53 of the flange 51 with respect to the imaginary plane VS is, for example, in the range of 5° to 45°, preferably in the range of 10° to 40°, and more preferably in the range of 20° to 30°. The inclination angle θ of the joint surface 53 of the flange 51 is not limited to the above angle range. The inclination angle θ is set appropriately within a range that allows the magnetic sensor module 20 to be mounted within the housing of the electric power steering system 1, ensures the bonding strength between the flange 51 and the connector housing 50, and ensures the area of the connector opening 52.

The joint surface 53 of the flange 51 is inclined from one axial side of the sensor housing 30 toward the other axial side of the sensor housing 30 so as to approach the central axis CL of the sensor housing 30. On the other hand, the surface 35 of the sensor housing side flange 33 on the flange 51 side is also inclined from one axial side of the sensor housing 30 toward the other axial side of the sensor housing 30 so as to approach the central axis CL of the sensor housing 30. In the present embodiment, the surface 35 of the sensor housing side flange 33 on the flange 51 side and the joint surface 53 of the flange 51 are joined by laser welding.

In the present embodiment, the sensor housing side flange 33 and the flange 51 are joined by laser welding, and therefore the following configuration is adopted.

Firstly, when viewed from a direction perpendicular to the joint surface 53 of the flange 51, the entire periphery of the flange 51 extends so as to surround the outside of the connector housing 50. In FIG. 8, an arrow a indicates the range in which the portion of the flange 51 on one axial side of the sensor housing 30 extends outward from the connector housing 50 when viewed from a direction perpendicular to the joint surface 53 of the flange 51. Also, when viewed from a direction perpendicular to the joint surface 53 of the flange 51, the range in which the portion of the flange 51 on the other axial side of the sensor housing 30 extends outward from the connector housing 50 is indicated by an arrow. In addition, when viewed from a direction perpendicular to the joint surface 53 of the flange 51, the portion of the flange 51 on the front side of the paper in FIG. 8 also extends outward from the connector housing 50, and the portion of the flange 51 on the back side of the paper in FIG. 8 also extends outward from the connector housing 50. These points are illustrated in FIG. 7.

When viewed from a direction perpendicular to the joint surface 53 of the flange 51, the range in which the flange 51 extends outward from the connector housing 50 is large enough that an upper jig 71 of a laser welding device 70 described later can apply pressure to the flange 51. This makes it possible to prevent foaming from occurring on the welding surface between the flange 51 and the sensor housing side flange 33 when laser welding is performed.

In addition, when viewed from a direction perpendicular to the joint surface 53 of the flange 51, the range in which the flange 51 extends outward from the connector housing 50 is preferably set to a size that allows laser light to be irradiated onto the flange 51 when the upper jig 71 of the laser welding device 70 is pressing against the flange 51. The laser beam can be irradiated onto the flange 51 from a direction perpendicular to the joint surface 53 of the flange 51. However, the present disclosure is not limited to this configuration, and the laser light may be irradiated onto the flange 51 from a direction oblique to the joint surface 53 of the flange 51.

Secondly, the sensor housing side flange 33 is made of a resin that has a higher laser light absorption capacity than the resin that forms the flange 51. The flange 51 is made of a resin that has a higher laser light transmittance than the resin that forms the sensor housing side flange 33. The flange 51 has a thickness that allows laser light to pass through. This allows the sensor housing side flange 33 and the flange 51 to be laser welded together.

Thirdly, a recess 55 recessed toward one axial side of the sensor housing 30 is provided in the connector housing 50 at the location where the flange 51 is connected to the other axial side of the sensor housing 30. Even when the area where the flange 51 extends outward beyond the connector housing 50 is small as viewed from a direction perpendicular to the joint surface 53 of the flange 51, laser welding can still be performed by irradiating the laser beam onto the joint surface 53 of the flange 51 from an oblique direction.

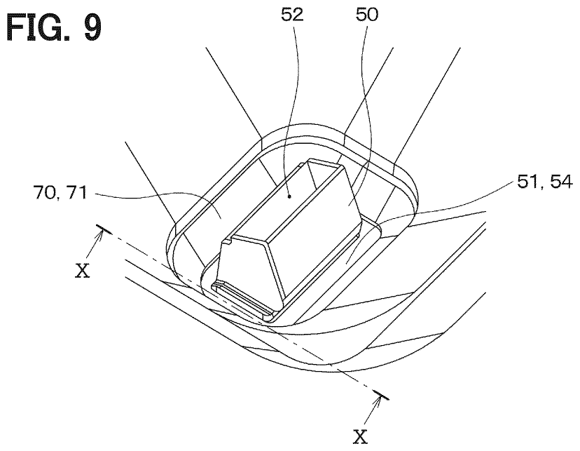

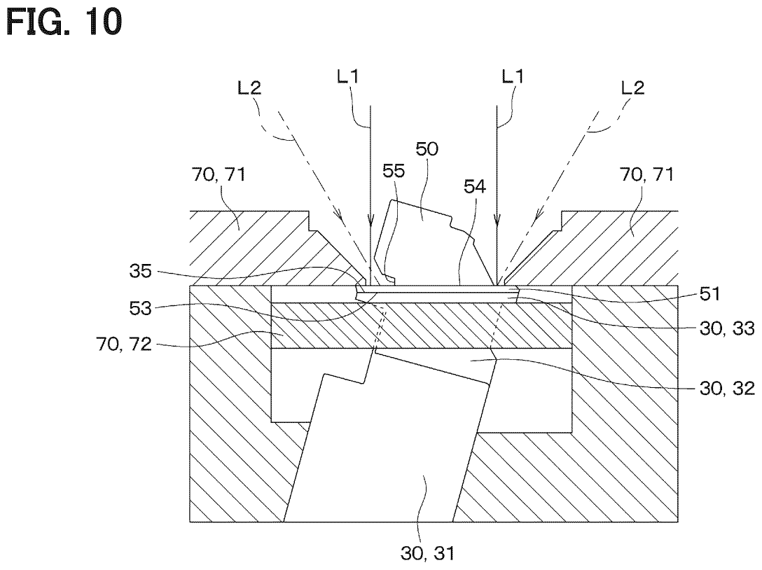

Next, a method of laser welding the flange 51 and the sensor housing side flange 33 in the manufacturing process of the magnetic sensor module 20 will be described with reference to FIGS. 9 and 10. In this description, for convenience, the upper side of the paper in FIG. 10 will be referred to as “top” and the lower side of the paper in FIG. 10 will be referred to as “bottom.”

As shown in FIGS. 9 and 10, the laser welding of the flange 51 and the sensor housing side flange 33 is performed with the circuit board 41, the magnetic detection element 40 mounted on the circuit board 41, and a portion of the connector housing 50 inserted inside the sensor housing extension portion 32.

First, the sensor housing side flange 33 is placed on the lower jig 72 of the laser welding device 70. Next, the upper jig 71 of the laser welding device 70 is placed on the laser welding of the flange 51. Then, the upper jig 71 and the lower jig 72 apply pressure to the flange 51 and the sensor housing side flange 33 over the entire periphery.

Next, as indicated by the solid line L1 in FIG. 10, while the flange 51 and the sensor housing side flange 33 are pressed together, a laser beam is irradiated from a direction perpendicular to the joint surface 53 of the flange 51. The laser light travels around the outside of the connector housing 50 and is irradiated onto the entire periphery of the flange 51. The laser light passes through the flange 51 and is absorbed by the sensor housing side flange 33. As a result, the boundary surface between the flange 51 and the sensor housing side flange 33 is laser welded. As shown by the dashed line L2 in FIG. 10, the laser beam may be irradiated onto the joint surface 53 of the flange 51 from an oblique direction.

Thereafter, the irradiation of the laser light is stopped, the upper jig 71 is removed from the flange 51, and then the magnetic sensor module 20 is removed from the laser welding device 70. By this method, the laser welding between the flange 51 and the sensor housing side flange 33 is completed.

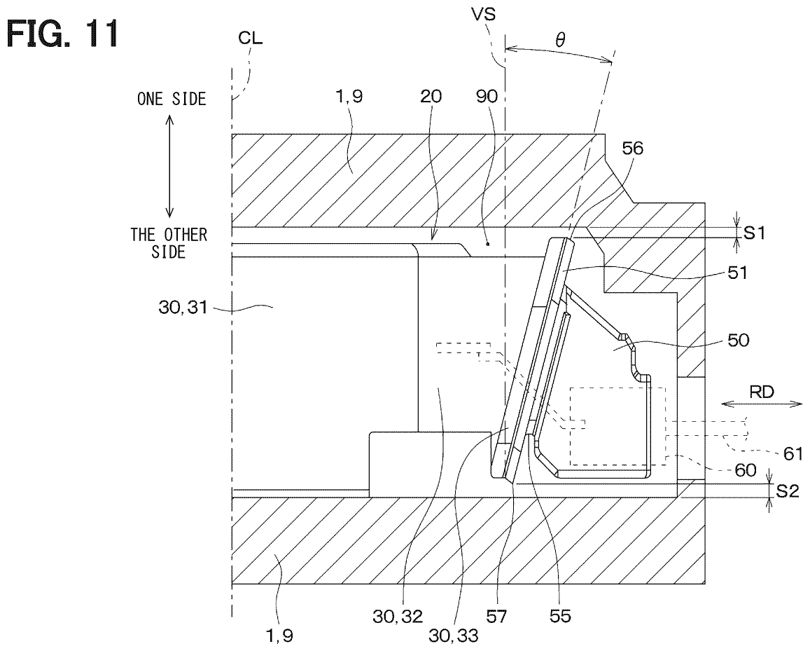

The magnetic sensor module 20 is used as a part of the torque sensor device 10, and is mounted in a mounting space 90 in the housing 9 of the electric power steering system 1, as shown in FIG. 11.

As shown in S1 of FIG. 11, the magnetic sensor module 20 of the present embodiment can ensure clearance between the outer edge 56 of the flange 51 on one axial side of the sensor housing 30 and an inner wall of the housing 9 of the electric power steering system 1. In addition, as shown in S2 of FIG. 11, the magnetic sensor module 20 of the present embodiment can also ensure clearance between the outer edge 57 of the flange 51 on the other axial side of the sensor housing 30 and the inner wall of the housing 9 of the electric power steering system 1.

Here, a magnetic sensor module 200 of a first comparative example will be described for comparison with the magnetic sensor module 20 of the first embodiment.

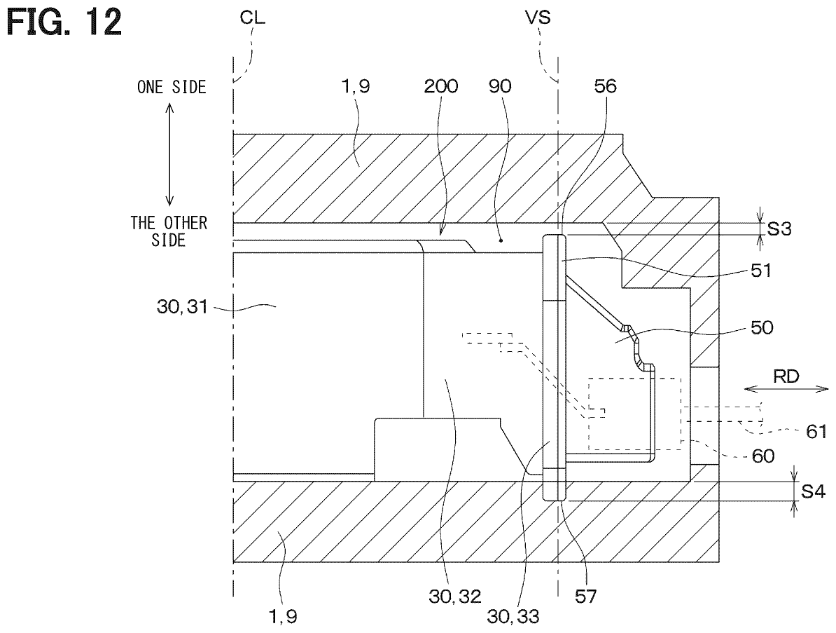

As shown in FIG. 12, in the magnetic sensor module 200 of the first comparative example, the flange 51 is formed parallel to the imaginary plane VS. In the magnetic sensor module 200 of the first comparative example, the area of the joint surface 53 of the flange 51 and the area of the connector opening 52 are the same as those of the magnetic sensor module 20 of the first embodiment. As shown in S3 of FIG. 12, the magnetic sensor module 200 of the first comparative example can ensure clearance between the outer edge 56 of the flange 51 on one axial side of the sensor housing 30 and an inner wall of the housing 9 of the electric power steering system 1. However, as shown in S4 of FIG. 12, in the magnetic sensor module 200 of the first comparative example, the outer edge 57 of the flange 51 on the other axial side of the sensor housing 30 interferes with the housing 9 of the electric power steering system 1. Therefore, the magnetic sensor module 200 of the first comparative example cannot be mounted or is difficult to mount in the mounting space 90 within the housing 9 of the electric power steering system 1.

Compared to the magnetic sensor module 200 of the first comparative example, the magnetic sensor module 20, the torque sensor device 10, and the sensor device of the first embodiment have the following advantages.

(1) The magnetic sensor module 20 of the first embodiment includes a pair of magnetic flux guide members 21 and 22, the sensor housing 30, the magnetic detection element 40, the connector housing 50, and the flange 51. The flange 51 has the joint surface 53 facing the sensor housing 30 and joined to the sensor housing 30. The joint surface 53 of the flange 51 is inclined with respect to the imaginary plane VS perpendicular to the element insertion direction ID.

As a result, the magnetic sensor module 20 can be made smaller in size while ensuring the area of the joint surface 53 that can ensure the joining strength between the flange 51 and the connector housing 50, and the area of the connector opening 52 into which the external connector 60 is inserted. Therefore, the magnetic sensor module 20 can be mounted in a narrow mounting space 90 inside the housing 9 of a vehicle-side system such as the electric power steering system 1.

Furthermore, even if the distance between the sensor device and the ECU 7 varies depending on the vehicle model, the magnetic sensor module 20 of the first embodiment can be installed simply by changing the length of the wiring 61 provided in the external connector 60. Therefore, the magnetic sensor module 20 does not need to have its specifications changed depending on the type of vehicle in which it is installed, and design costs and manufacturing costs can be reduced.

(2) The torque sensor device 10 of the first embodiment includes the torsion bar 13, the multi-pole magnet 14, the pair of yokes 15 and 16, and the magnetic sensor module 20 described in (1) above.

According to this configuration, the torque sensor device 10 can reduce the size of the magnetic sensor module 20, allowing it to be installed even in the limited mounting space 90 within the housing 9 of a vehicle system, such as the electric power steering system 1. Furthermore, since the torque sensor device 10 has a detachable external connector 60, there is no need to change the specifications depending on the vehicle model in which it is installed, which reduces design and manufacturing costs.

(3) The sensor device of the first embodiment includes a sensor body that detects a change in a physical quantity, the sensor housing 30 that houses at least a portion of the sensor body, the connector housing 50, and the flange 51. The flange 51 has the joint surface 53 facing the sensor housing 30 and joined to the sensor housing 30. The joint surface 53 of the flange 51 is inclined with respect to the imaginary plane VS perpendicular to the element insertion direction ID.

The sensor device detects various physical quantities. When the sensor device corresponds to the magnetic sensor module 20 described in (1) above, the sensor body of the sensor device is composed of a pair of magnetic flux guide members 21, 22 and the like.

Furthermore, when the sensor device corresponds to the torque sensor device 10 described in (2) above, the sensor body of the sensor device is composed of a torsion bar 13, a multi-pole magnet 14, a pair of yokes 15 and 16, and a pair of magnetic flux guide members 21 and 22, etc. In this case, the sensor housing 30 accommodates a pair of magnetic flux guide members 21 and 22.

Therefore, the sensor device can achieve the same effects as the magnetic sensor module described in (1) above and the torque sensor device described in (2) above.

(4) In the first embodiment, when viewed from a direction perpendicular to the joint surface 53 of the flange 51, the entire periphery of the flange 51 extends so as to surround the outside of the connector housing 50.

This makes it possible to apply pressure to the entire circumference of the flange 51 and the sensor housing 30, and then irradiate laser light perpendicular to the joint surface 53 to perform laser welding between the flange 51 and the sensor housing 30. The laser light may be irradiated onto the joint surface 53 from an oblique direction.

(5) In the first embodiment, the joint surface 53 of the flange 51 and the sensor housing 30 are joined together along the entire outer periphery of the connector housing 50 by laser welding.

This can prevent water and the like from entering the inside of the sensor device through the joint portion between the flange 51 and the sensor housing 30.

Furthermore, in the present embodiment, the wiring is not fixed to the components that make up the magnetic sensor module 20, so the wiring does not get in the way when laser welding is performed, making laser welding easy.

(6) In the first embodiment, the joint surface 53 and the non-joint surface 54 of the flange 51 are formed parallel to each other.

This allows the plate thickness of the flange 51 to be constant, and prevents variations in the joining strength of the laser welding over the entire circumference of the flange 51.

(7) In the first embodiment, the surface 35 of the sensor housing side flange 33 of the sensor housing 30 on the flange 51 side is inclined in the same direction as the flange 51 with respect to the imaginary plane VS perpendicular to the element insertion direction ID, and is joined to the flange 51.

This allows the sensor housing side flange 33 to be placed on the lower jig 72 of the laser welding device 70, and pressure can be applied to the flange 51 and the sensor housing side flange 33 over the entire periphery. Therefore, when laser welding is performed, foaming can be prevented from occurring on the welding surface between the flange 51 and the sensor housing side flange 33.

(8) In the first embodiment, the flange 51 is made of a resin that has a higher laser light transmittance than the resin that forms the sensor housing side flange 33, and has a thickness that allows the laser light to pass through.

This allows the flange 51 and the sensor housing 30 to be reliably laser welded together.

(9) In the first embodiment, the joint surface 53 of the flange 51 is inclined from one side to the other side in the direction in which the central axis CL of the sensor housing 30 extends so as to approach the central axis CL of the sensor housing 30. At the other side of the connector housing 50 in the direction in which the central axis CL of the sensor housing 30 extends, a recess 55 is provided at the point where it connects to the flange 51, which is recessed to one side in the direction in which the central axis CL of the sensor housing 30 extends.

According to this configuration, even if the area of the flange 51 extending outward from the connector housing 50 when viewed from a direction perpendicular to the joint surface 53 of the flange 51 is small, by providing a recess 55 in the connector housing 50, it is possible to irradiate the flange 51 with laser light from an oblique direction. Therefore, the flange 51 and the connector housing 50 can be laser welded together.

(10) In the first embodiment, the magnetic flux collectors 23 and 24 of the pair of magnetic flux guide members 21 and 22 are provided in an annular or arc-shaped configuration on the radially outer side of the pair of yokes 15 and 16.

This allows the area in which the pair of yokes 15, 16 and the pair of magnetic flux guide members 21, 22 face each other in the radial direction to be increased. Therefore, the magnetic flux density guided from the pair of yokes 15 and 16 to the pair of magnetic flux guide members 21 and 22 can be increased, and the SN (signal-to-noise) ratio can be increased, thereby improving the torque detection accuracy.

### Second Embodiment

A second embodiment will be described. The second embodiment differs from the first embodiment in that the configuration of the magnetic sensor module 20 is partially changed, but the rest is the same as the first embodiment, so only the parts that are different from the first embodiment will be described.

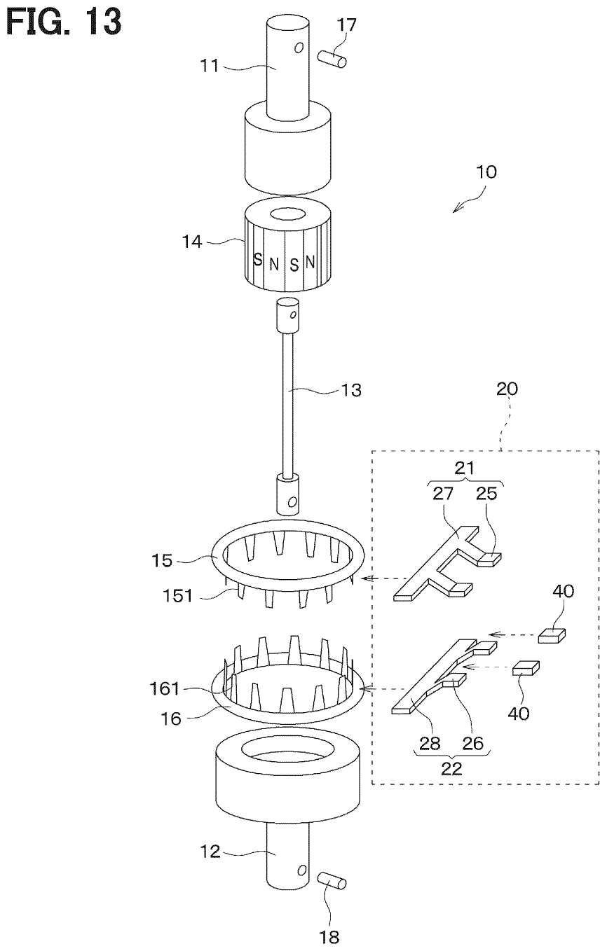

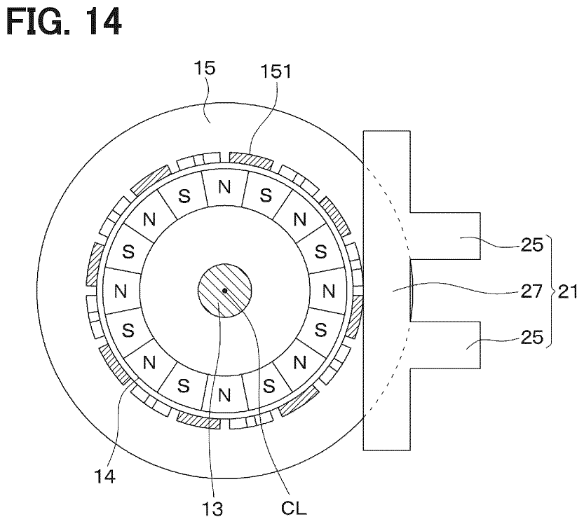

As shown in FIG. 13, the torque sensor device 10 as a sensor device of the second embodiment also includes a torsion bar 13, a multi-pole magnet 14, a pair of yokes 15 and 16, and a magnetic sensor module 20, similar to the first embodiment. As shown in FIGS. 13 and 14, the pair of magnetic flux guide members 21 and 22 included in the magnetic sensor module 20 are provided in a bar shape on parts of the radially outer sides of the pair of yokes 15 and 16. Specifically, the pair of magnetic flux guide members 21, 22 have rectangular band-shaped magnetic collectors 27, 28 that are arranged on a portion of the radially outer side of the pair of yokes 15, 16, and extension portions 25, 26 that extend radially outward from the magnetic collectors 27, 28. The shapes of the pair of magnetic flux guide members 21, 22 are not limited to those shown in FIGS. 13 and 14, and for example, the magnetic collectors 27, 28 may be arc-shaped, wavy, elliptical, or polygonal, or may have a shape having protrusions (not shown) for fixing them to the sensor housing 30.

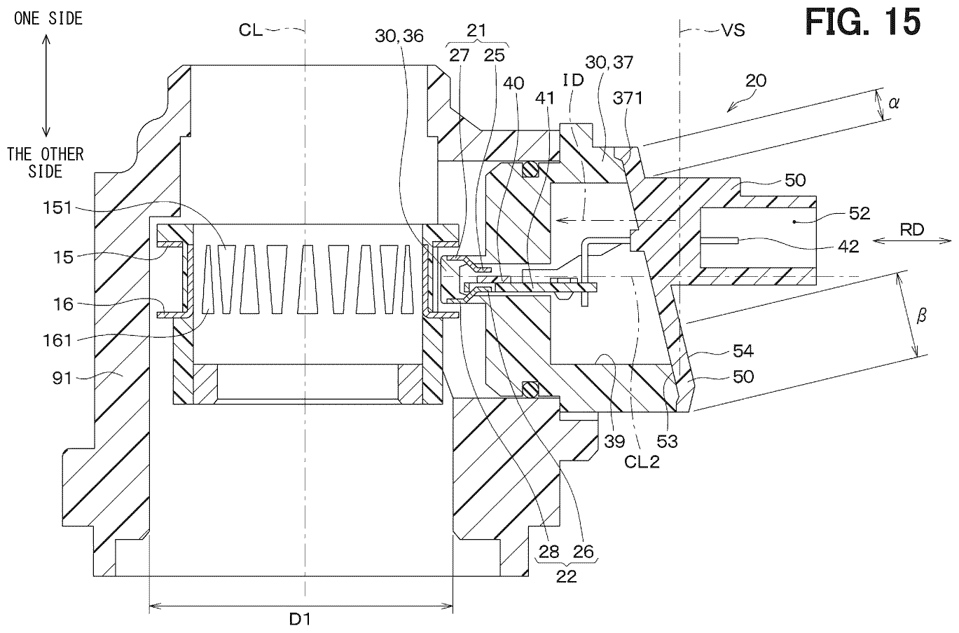

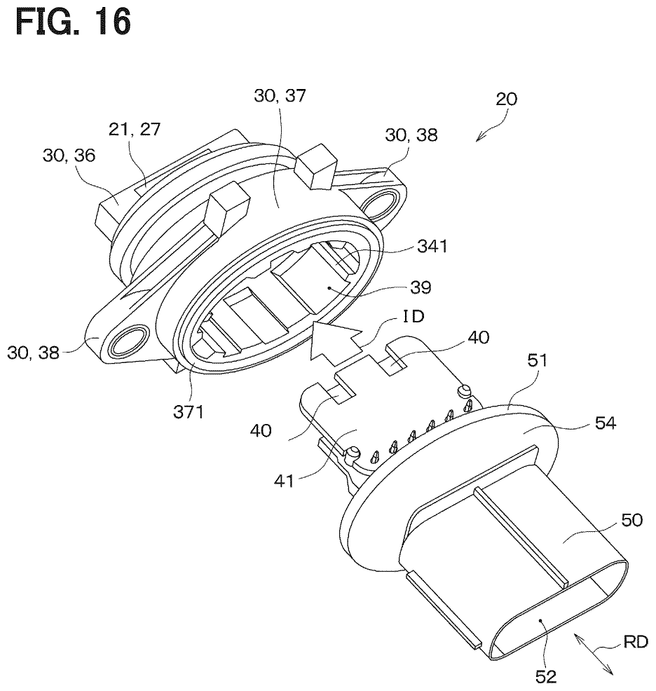

As shown in FIG. 15, the pair of magnetic flux guide members 21 and 22 are fixed to the sensor housing 30. As shown in FIGS. 15 and 16, the sensor housing 30 has a magnetic flux guide member attachment portion 36, a cylindrical portion 37, and a housing attachment portion 38 that protrudes outward from the cylindrical portion 37. In the second embodiment, the central axis CL2 of the cylindrical portion 37 of the sensor housing 30 is perpendicular to the central axis CL of the yokes 15 and 16. In the following description, a direction in which the central axis CL of the yokes 15 and 16 extends will be referred to as the “axial direction of the yokes 15 and 16.” The central axis CL of the yokes 15 and 16, the central axis CL of the torsion bar 13, and the central axis CL of the steering shaft 3 coincide with each other.

As indicated by the arrow ID in FIG. 16, the magnetic detection element 40 mounted on the circuit board 41 together with a part of the connector housing 50 is inserted into the opening 39 of the cylindrical portion 37 of the sensor housing 30. In the description of the second embodiment, the direction in which the magnetic detection element 40 mounted on the circuit board 41 together with a part of the connector housing 50 is inserted into the opening 39 of the cylindrical portion 37 of the sensor housing 30 is also referred to as the “element insertion direction ID.” A guide 341 is provided inside the cylindrical portion 37 of the sensor housing 30 to guide the circuit board 41 and other components when they are inserted. The guide 341 extends parallel to the direction in which the magnetic detection element 40 and the circuit board 41 are inserted into the connector housing 50 (i.e., the element insertion direction ID). Therefore, when the torque sensor device 10 and the magnetic sensor module 20 are completed, the element insertion direction ID can be confirmed as the in-plane direction of the circuit board 41, the extension direction of the guide 341, or the extension direction of the axis of the cylindrical portion 37 of the sensor housing 30. Alternatively, the element insertion direction ID can be confirmed as the direction in which the magnetic detection element 40 is inserted between the first extension portion 25 and the second extension portion 26.

The magnetic detection element 40 is disposed between the first extension portion 25 and the second extension portion 26. The joint surface 53 of the flange 51 is joined to a surface 371 of the cylindrical portion 37 of the sensor housing 30 on the flange 51 side.

The connector housing 50 and the flange 51 are integrally formed by resin injection molding. The connector housing 50 is provided with the circuit board 41 on which the magnetic detection element 40 is mounted, and the terminal 42 electrically connected to the magnetic detection element 40. The connector housing 50 is provided with a cylindrical connector opening 52 to which an external connector 60 can be attached and detached. In the second embodiment, the external connector attachment/detachment direction RD, the element insertion direction ID, and the direction in which the central axis CL2 of the cylindrical portion 37 of the sensor housing 30 extends are aligned.

The flange 51 extends outward from the connector housing 50. The flange 51 extends outward from the entire periphery of a surface of the connector housing 50 that faces in a direction intersecting the element insertion direction ID and the external connector attachment/detachment direction RD. The flange 51 is formed in a plate shape and is inclined with respect to an imaginary plane VS perpendicular to the element insertion direction ID. It can also be said that the flange 51 is inclined with respect to an imaginary plane VS perpendicular to the circuit board 41. It can also be said that the flange 51 is inclined with respect to the imaginary plane VS parallel to the central axis CL of the torsion bar 13. It can also be said that the flange 51 is inclined with respect to the imaginary plane VS perpendicular to the external connector attachment/detachment direction RD. It can also be said that the flange 51 is inclined with respect to the imaginary plane VS perpendicular to the axis of the cylindrical portion 37 of the sensor housing 30.

The surface of the flange 51 facing the sensor housing 30, i.e., the joint surface 53, is joined to the cylindrical portion 37 of the sensor housing 30. The surface of the flange 51 facing away from the joint surface 53 is called a non-joint surface 54. The joint surface 53 and the non-joint surface 54 of the flange 51 are formed parallel to each other. Both the joint surface 53 and the non-joint surface 54 of the flange 51 are inclined with respect to the imaginary plane VS.

In the second embodiment, the surface 371 of the cylindrical portion 37 of the sensor housing 30 on the flange 51 side and the joint surface 53 of the flange 51 are also joined by laser welding.

In the second embodiment, the sensor housing 30 and the flange 51 are joined by laser welding, and therefore the following configuration is adopted.

Firstly, when viewed from a direction perpendicular to the joint surface 53 of the flange 51, the entire periphery of the flange 51 extends so as to surround the outside of the connector housing 50. In FIG. 15, the arrow a indicates the range in which the portion of the flange 51 on one axial side of the yokes 15 and 16 extends outward from the connector housing 50 when viewed from a direction perpendicular to the joint surface 53 of the flange 51. Also, when viewed from a direction perpendicular to the joint surface 53 of the flange 51, the range in which the portion of the flange 51 on the other axial side of the yokes 15 and 16 extends outward from the connector housing 50 is indicated by an arrow β. In addition, when viewed from a direction perpendicular to the joint surface 53 of the flange 51, the portion of the flange 51 on the front side of the paper in FIG. 15 also extends outward from the connector housing 50, and the portion of the flange 51 on the back side of the paper in FIG. 15 also extends outward from the connector housing 50. These points are illustrated in FIG. 16.

Secondly, the cylindrical portion 37 of the sensor housing 30 is made of a resin that has a higher laser light absorption capacity than the resin that forms the flange 51. The flange 51 is made of a resin that has a higher laser light transmittance than the resin that forms the cylindrical portion 37 of the sensor housing 30. The flange 51 has a thickness that allows laser light to pass through. This allows the cylindrical portion 37 of the sensor housing 30 and the flange 51 to be laser welded together.

In the second embodiment, the connector housing 50 may also be provided with the recess 55 described in the first embodiment.

The magnetic sensor module 20 is used as a part of the torque sensor device 10 and is mounted in a mounting space 90 within the housing 9 of the electric power steering system 1.

The magnetic sensor module 20, the torque sensor device 10, and the sensor device according to the second embodiment described above also achieve the same effects as those described in the first embodiment.

Furthermore, in the second embodiment, the pair of magnetic flux guide members 21 and 22 are provided in a bar shape on a part of the radially outer side of the pair of yokes 15 and 16.

As a result, the torque sensor device 10 of the second embodiment can reduce the inner diameter D1 of the portion 91 of the system-side housing that houses the pair of yokes 15, 16, compared to that of the first embodiment.

### Third Embodiment

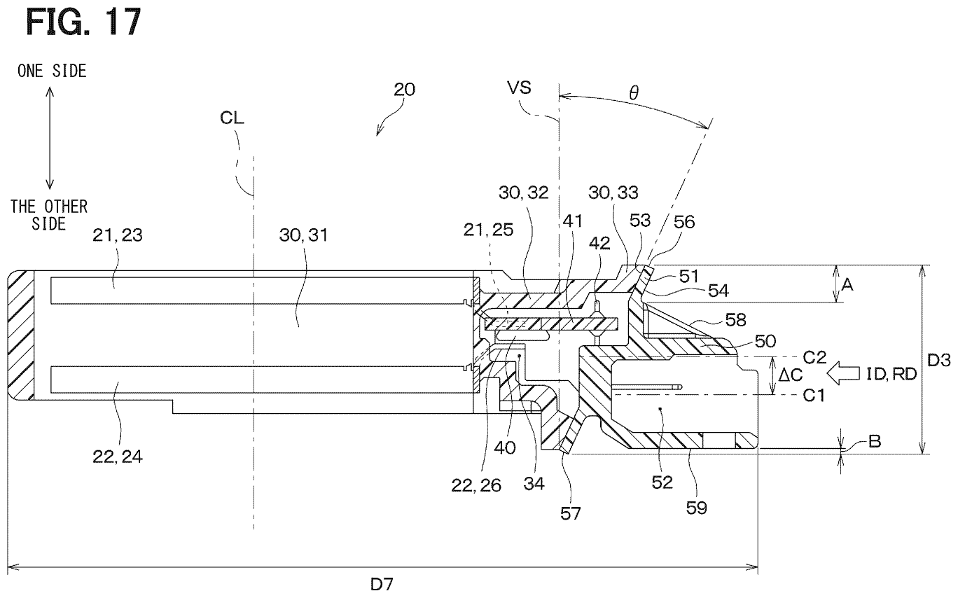

A third embodiment will be described. Similar to the first embodiment, the sensor device of the third embodiment is a torque sensor device 10 applied to the electric power steering system 1 shown in FIG. 1 and the like. As shown in FIG. 17, the torque sensor device 10 includes a magnetic sensor module 20 similar to that of the first embodiment. The magnetic sensor module 20 includes a first magnetic flux guide member 21, a second magnetic flux guide member 22, a sensor housing 30, a magnetic detection element 40, a connector housing 50, and a flange 51. Hereinafter, the first magnetic flux guide member 21 and the second magnetic flux guide member 22 will be referred to as a “pair of magnetic flux guide members 21, 22.” The pair of magnetic flux guide members 21 and 22 have magnetic flux collectors 23 and 24 and extension portions 25 and 26.

The pair of magnetic flux guide members 21 and 22 are housed in the sensor housing 30. Specifically, the pair of magnetic flux guide members 21 and 22 are fixed to the sensor housing 30 by resin molding or the like.

The sensor housing 30 has a part formed in a cylindrical shape. Specifically, the sensor housing 30 has a sensor housing main body 31 formed in a cylindrical shape, a sensor housing extension portion 32 extending from the sensor housing main body 31 toward the connector housing 50, and a sensor housing side flange 33 extending outward from the sensor housing extension portion 32. The magnetic flux collectors 23, 24 of the pair of magnetic flux guide members 21, 22 are fixed to the radially inner portion of the sensor housing main body 31, and the extension portions 25, 26 extend from the magnetic flux collectors 23, 24 to the inside of the sensor housing extension portion 32.

In the following description, the central axis CL of the inner peripheral surface of the sensor housing main body 31 will be referred to as the “central axis CL of the sensor housing 30.” The central axis CL of the sensor housing 30, the central axis CL of the torsion bar 13 described in the first embodiment, and the central axis CL of the steering shaft 3 coincide with each other. In addition, the radial direction of a virtual circle drawn on a plane perpendicular to the central axis CL of the sensor housing 30 with the central axis CL as its center is referred to as a “radial direction,” the circumferential direction of that virtual circle is called the “circumferential direction,” and the direction in which the central axis CL extends is referred to as an “axial direction.” The upper side in FIG. 17 is referred to as the “one axial direction side,” and the lower side in FIG. 17 is referred to as the “other axial direction side.”

The magnetic detection element 40 mounted on the circuit board 41 together with a part of the connector housing 50 is inserted into the opening 34 of the sensor housing extension portion 32. The magnetic detection element 40 is mounted on the circuit board 41 and is disposed between the first extension portion 25 and the second extension portion 26 in a state where it is inserted into the opening 34 of the sensor housing extension portion 32. The direction in which the magnetic detection element 40 mounted on the circuit board 41 is inserted into the opening 34 of the sensor housing extension portion 32 is referred to as the “element insertion direction ID.” The element insertion direction ID can be confirmed as the in-plane direction of the circuit board 41 or the direction in which the axis of the sensor housing extension portion 32 extends. Alternatively, the element insertion direction ID can be confirmed as the direction in which the magnetic detection element 40 is inserted between the first extension portion 25 and the second extension portion 26 of the pair of magnetic flux guide members 21 and 22.

A flange 51 on the connector housing 50 side is joined to the sensor housing side flange 33. The sensor housing side flange 33 and the flange 51 are joined together by, for example, laser welding.

The connector housing 50 and the flange 51 are integrally formed by resin injection molding. The connector housing 50 is provided with the circuit board 41 on which the magnetic detection element 40 is mounted, and the terminal 42 electrically connected to the magnetic detection element 40 via wiring on the circuit board 41. The connector housing 50 is provided with the cylindrical connector opening 52 to which an external connector (not shown) can be attached and detached. One end of the terminal 42 is connected to the magnetic detection element 40, and the other end is exposed to the connector opening 52. In the present embodiment, the external connector attachment/detachment direction RD and the element insertion direction ID are parallel to each other. In addition, in the present embodiment, the external connector attachment/detachment direction RD and the element insertion direction ID intersect (specifically, are perpendicular to) the central axis CL of the sensor housing 30.

The flange 51 extends outward from the connector housing 50. Specifically, the flange 51 extends outward from the entire periphery of the outer wall surface of the connector housing 50 that faces in a direction intersecting the element insertion direction ID and the external connector attachment/detachment direction RD.

The flange 51 is formed in a plate shape and is inclined with respect to an imaginary plane VS perpendicular to the element insertion direction ID. The surface of the flange 51 facing the sensor housing 30 is the joint surface 53 that is joined to the sensor housing side flange 33. The non-joint surface 54 of the flange 51 facing the opposite side to the joint surface 53 and the joint surface 53 of the flange 51 are formed parallel to each other. Both the joint surface 53 and the non-joint surface 54 of the flange 51 are inclined with respect to the imaginary plane VS. The inclination angle θ of the joint surface 53 of the flange 51 with respect to the imaginary plane VS is as described in the first embodiment.

Here, the connector housing 50 is provided at a position offset from the flange 51 to the other side in the axial direction. More specifically, the axial center position C1 of the connector opening 52 is shifted to the other axial side with respect to the axial center position C2 of the flange 51. The deviation AC between the two center positions C1 and C2 is greater than the manufacturing tolerance that would occur when the two center positions C1 and C2 were to coincide with each other. Although not limited thereto, it is preferable that the deviation AC between the two center positions C1 and C2 is greater than 10% of the distance D3 along the central axis CL of the sensor housing 30 at the flange 51.

The fact that the connector housing 50 is provided at a position shifted to the other axial side with respect to the flange 51 can also be stated as follows. The distance along the central axis CL of the sensor housing 30 between the outer wall 58 on one axial side of the connector housing 50 and the outer edge 56 on one axial side of the flange 51 is defined as A. The distance along the central axis CL of the sensor housing 30 between the outer wall 59 on the other axial side of the connector housing 50 and the outer edge 57 on the other axial side of the flange 51 is defined as B. At this time, the relationship A>B is satisfied.

The difference between the two distances A and B is greater than the manufacturing tolerance when the two distances A and B are assumed to be the same. Although not limited thereto, it is preferable that the distance B is smaller than 10% of the distance A. The distance B may be 0.

The effect of providing the connector housing 50 at a position offset to the other axial side relative to the flange 51 in the magnetic sensor module 20 of the present embodiment will be described in comparison with the magnetic sensor module 201 of a second comparative example.

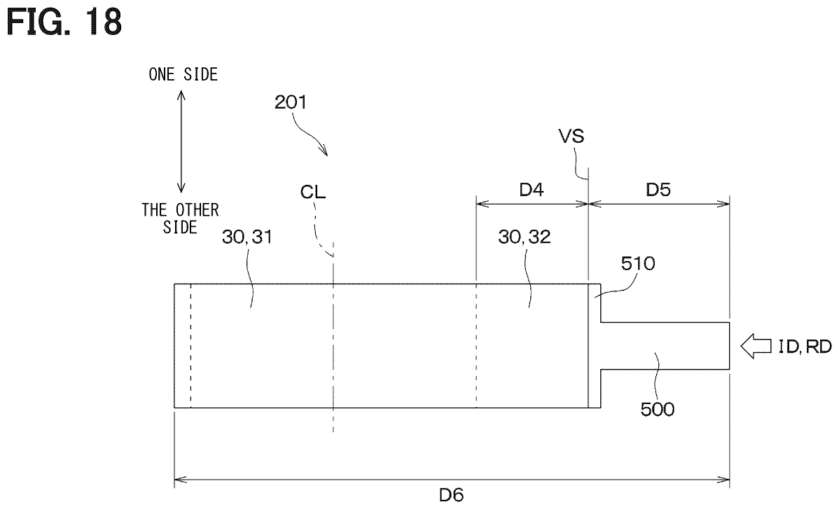

As shown in FIG. 18, in the magnetic sensor module 201 of the second comparative example, the flange 510 extending outward from the connector housing 500 is formed parallel to the imaginary plane VS perpendicular to the element insertion direction ID and the external connector attachment/detachment direction RD. In the magnetic sensor module 201 of the second comparative example, the radial size of the sensor housing extension portion 32 is defined as D4. The radial size of the flange 510 and the connector housing 500 is defined as D5. The radial size of the entire magnetic sensor module 201 is defined as D6.

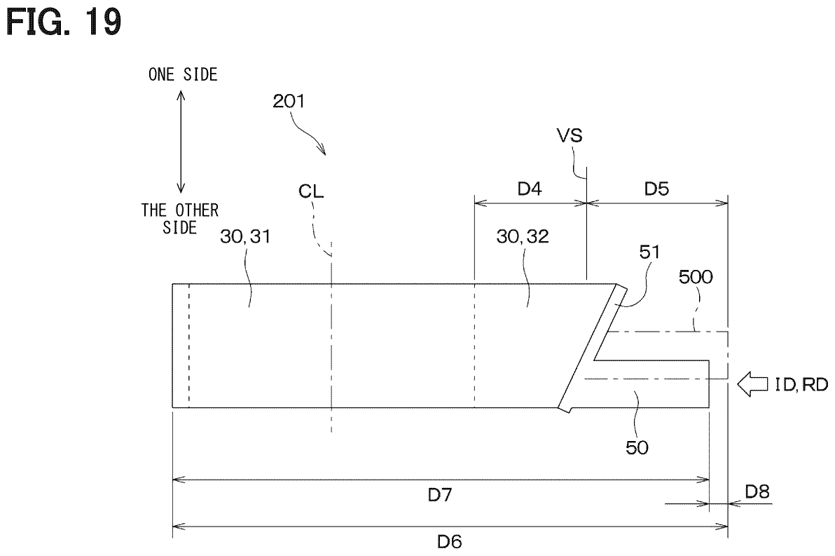

In contrast, as shown in FIG. 19, in the magnetic sensor module 20 of the present embodiment, a flange 51 extending outward from a connector housing 50 is inclined with respect to the imaginary plane VS. Furthermore, the connector housing 50 is provided at a position offset from the flange 51 to the other side in the axial direction. In FIG. 19, the position where the connector housing 500 of the magnetic sensor module 201 of the second comparative example is superimposed on the magnetic sensor module 20 of the present embodiment is indicated by a dashed dotted line. In the present embodiment, the radial size D7 of the entire magnetic sensor module 20 can be reduced by a difference D8 compared to the radial size D6 of the entire magnetic sensor module 201 of the second comparative example.

As described above, in the third embodiment, the axial center position C1 of the connector opening 52 is shifted to the other axial side with respect to the axial center position C2 of the flange 51. As a result, the radial size D7 of the entire magnetic sensor module 20 can be made smaller than that shown in the second comparative example.

In addition, in the third embodiment, the distance A between the outer wall 58 on one axial side of the connector housing 50 and the outer edge 56 on one axial side of the flange 51 is greater than the distance B between the outer wall 59 on the other axial side of the connector housing 50 and the outer edge 57 on the other axial side of the flange 51. As a result, the radial size D7 of the entire magnetic sensor module 20 can be made smaller than that shown in the second comparative example. Therefore, the magnetic sensor module 20 can be mounted in a narrow mounting space 90 within the housing 9 of a vehicle-side system such as the electric power steering system 1, as shown in FIG. 11.

### Other Embodiments

(1) In the above embodiments, a torque sensor is used as an example of a sensor device, but the present disclosure is not limited to this configuration. For example, the sensor device may be a detection device that detects various physical quantities, such as a pressure sensor, an acceleration sensor, or a temperature sensor. In this case, the detection element is not limited to the magnetic detection element 40, but any element capable of converting the physical quantity detected by the sensor into an electrical signal may be used.
(2) In the above embodiments, the torque sensor device 10 is described as being applied to the electric power steering system 1, but the present disclosure is not limited to this configuration. The torque sensor device 10 may be applied to various vehicle systems.
(3) In the above embodiments, the input shaft 11 constituting the steering shaft 3 corresponds to the first shaft, and the output shaft 12 corresponds to the second shaft. However, the present disclosure is not limited to this configuration. For example, the output shaft 12 may correspond to the first shaft, and the input shaft 11 may correspond to the second shaft. In this case, the multi-pole magnet 14 is fixed to the other end of the output shaft 12 or the torsion bar 13, and the pair of yokes 15 and 16 are fixed to one end of the input shaft 11 or the torsion bar 13.
(4) In the first embodiment, the joint surface 53 of the flange 51 and the sensor housing side flange 33 of the sensor housing 30 are laser welded together. However, the present disclosure is not limited to this configuration. The joint surface 53 of the flange 51 and the sensor housing side flange 33 of the sensor housing 30 can be joined by various joining methods, such as joining with an adhesive, welding using heat, ultrasound or vibration, or joining with screws or rivets.
(5) In the first embodiment, the entire circumference of the flange 51 extends outside the connector housing 50 when viewed perpendicularly to the joint surface 53 of the flange 51. However, the present disclosure is not limited to this configuration. A configuration may be adopted in which a portion of the flange 51 extends outside the connector housing 50 when viewed from a direction perpendicular to the joint surface 53 of the flange 51.
(6) In the first embodiment, the joint surface 53 of the flange 51 and the sensor housing 30 are joined by laser welding around the entire periphery on the outside of the connector housing 50. However, the present disclosure is not limited to this configuration. The joint surface 53 of the flange 51 and the sensor housing 30 may be partially joined on the outside of the connector housing 50 by laser welding.
(7) In the first embodiment, the joint surface 53 of the flange 51 is described as being inclined from one axial side of the sensor housing 30 toward the other axial side of the sensor housing 30, approaching the central axis CL of the sensor housing 30, but the present disclosure is not limited to this configuration. The direction in which the joint surface 53 of the flange 51 is inclined can be set arbitrarily depending on, for example, the shape of the mounting space 90 for the magnetic sensor module 20 within the housing 9 of the vehicle system.
(8) In the first embodiment, the shape of the flange 51 when viewed from a direction perpendicular to the joint surface 53 of the flange 51 is approximately rectangular, and in the second embodiment, the shape is approximately circular, but the present disclosure is not limited to this configuration. The flange 51 may have various shapes, such as a polygonal shape, an elliptical shape, a circular shape, or a curved shape.

The present disclosure is not limited to the embodiments described above, and can be modified as appropriate. The above-described embodiments and a part thereof are not irrelevant to each other, and can be appropriately combined with each other unless the combination is obviously impossible. The constituent element(s) of each of the above embodiments is/are not necessarily essential unless it is specifically stated that the constituent element(s) is/are essential in the above embodiment, or unless the constituent element(s) is/are obviously essential in principle. A quantity, a value, an amount, a range, or the like referred to in the description of the embodiments described above is not necessarily limited to such a specific value, amount, range or the like unless it is specifically described as essential or understood as being essential in principle. Furthermore, a shape, positional relationship or the like of a structural element, which is referred to in the embodiments described above, is not limited to such a shape, positional relationship or the like, unless it is specifically described or obviously necessary to be limited in principle.

What is claimed is:

1. A sensor device mounted on a vehicle, comprising:
a sensor body configured to sense a change in physical quantity;
a sensor housing configured to accommodate at least a portion of the sensor body;
a connector housing having a detection element configured to output a signal corresponding to a change in the physical quantity, wherein a portion of the connector housing having the detection element is inserted into the sensor housing; and
a flange extending outward from the connector housing and having a joint surface facing the sensor housing that is joined to the sensor housing; wherein
the joint surface is inclined with respect to an imaginary plane perpendicular to a direction in which a portion of the connector housing having the detection element is inserted into the sensor housing.

2. The sensor device according to claim 1, wherein
at least a part of a circumference of the flange extends outside the connector housing when viewed from a direction perpendicular to the joint surface.

3. The sensor device according to claim 1, wherein
the joint surface and the sensor housing are joined by laser welding, either partially or entirely around the circumference, outside the connector housing.

4. The sensor device according to claim 1, wherein
a non-joint surface of the flange opposite to the joint surface is formed parallel to the joint surface.

5. The sensor device according to claim 1, wherein
the sensor housing has a sensor housing main body formed in a cylindrical shape and a sensor housing side flange to which the flange is joined, and
a surface of the sensor housing side flange on the flange side is inclined with respect to the imaginary plane in the same direction as the flange.

6. The sensor device according to claim 1, wherein
the flange is formed of a resin that is more transparent to a laser light than the resin that forms the sensor housing, and has a thickness sufficient to allow the laser light to pass through.

7. The sensor device according to claim 1, wherein
the sensor housing has a sensor housing main body formed in a cylindrical shape,
the joint surface is inclined from one side to the other side along a direction in which a central axis of the sensor housing main body extends so as to approach the central axis, and
a recess recessed to one side in the direction in which the central axis extends is provided at a portion of the connector housing on the other side in the direction in which the central axis extends, at a point where the connector housing is connected to the flange.

8. A torque sensor device for detecting an axial torque acting on a shaft, comprising:
a torsion bar that coaxially connects a first shaft and a second shaft that constitute the shaft and converts torque acting between the first shaft and the second shaft into a torsional displacement;
a multi-pole magnet fixed to one end side of the first shaft or the torsion bar, with N poles and S poles alternately arranged in a circumferential direction;
a yoke fixed to the other end of the second shaft or the torsion bar outside the multi-pole magnet and forming a magnetic circuit within a magnetic field of the multi-pole magnet;
a first magnetic flux guide member and a second magnetic flux guide member provided outside the yoke and guiding a magnetic flux flowing through the yoke;
a sensor housing for fixing the first magnetic flux guide member and the second magnetic flux guide member;
a magnetic detection element that outputs a signal according to a magnetic flux density passing through a portion where the first magnetic flux guide member and the second magnetic flux guide member are adjacent to each other;
a connector housing including the magnetic detection element, wherein a portion in which the magnetic detection element is provided being inserted into the sensor housing; and
a flange extending outward from the connector housing and having a joint surface facing the sensor housing that is joined to the sensor housing; wherein
the joint surface is inclined with respect to an imaginary plane perpendicular to a direction in which a portion of the connector housing having the magnetic detection element is inserted into the sensor housing.

9. The torque sensor device according to claim 8, wherein
the torsion bar is twisted and elastically deformed in response to a torque about an axis that acts between the first shaft and the second shaft,
the yoke has a first yoke and a second yoke, and the amount of magnetic flux flowing between the first yoke and the second yoke changes as a relative position of the multi-pole magnet in the rotational direction changes according to the amount of torsional displacement of the torsion bar,
the first magnetic flux guide member has a first magnetic flux collector that collects the magnetic field of the first yoke, and the second magnetic flux guide member has a second magnetic flux collector that collects the magnetic field of the second yoke, and
the magnetic detection element converts the magnetic flux collected by the first magnetic flux guide member and the second magnetic flux guide member into an electric signal and outputs the electric signal.

10. The torque sensor device according to claim 8, wherein
the first magnetic flux guide member has a first magnetic flux collector formed in an annular or arc shape on the radially outer side of the yoke, and
the second magnetic flux guide member has a second magnetic flux collector formed in an annular or arc shape on a radially outer side of the yoke.

11. The torque sensor device according to claim 8, wherein
the first magnetic flux guide member has a first magnetic flux collector formed in a bar shape on a part of the radially outer side of the yoke, and
the second magnetic flux guide member has a second magnetic flux collector formed in a bar shape on a part of the radially outer side of the yoke.

12. The torque sensor device according to claim 8, wherein
the torque sensor device is configured to be mounted in a mounting space within a housing of an electric power steering system.

13. A magnetic sensor module for detecting magnetic flux flowing through a yoke, comprising:
a first magnetic flux guide member and a second magnetic flux guide member for guiding magnetic flux flowing through the yoke;
a sensor housing that houses the first magnetic flux guide member and the second magnetic flux guide member;
a magnetic detection element that outputs a signal according to a magnetic flux density passing through a portion where the first magnetic flux guide member and the second magnetic flux guide member are adjacent to each other;
a connector housing including the magnetic detection element, wherein a portion of connector housing having the magnetic detection element is inserted into the sensor housing; and
a flange extending outward from the connector housing and having a joint surface facing the sensor housing that is joined to the sensor housing; wherein
the joint surface is inclined with respect to an imaginary plane perpendicular to a direction in which a portion of the connector housing having the magnetic detection element is inserted into the sensor housing.

14. The magnetic sensor module according to claim 13, wherein
the first magnetic flux guide member has a first magnetic flux collector formed in an annular or arc shape on a radially outer side of the yoke, and
the second magnetic flux guide member has a second magnetic flux collector formed in an annular or arcuate shape on a radially outer side of the yoke.

15. The magnetic sensor module according to claim 13, wherein
the first magnetic flux guide member has a first magnetic flux collector formed in a bar shape on a part of the radially outer side of the yoke, and
the second magnetic flux guide member has a second magnetic flux collector formed in a bar shape on a part of the radially outer side of the yoke.

16. The magnetic sensor module according to claim 13, wherein
the magnetic sensor module is configured to be mounted in a mounting space within a housing of an electric power steering system.

17. The sensor device according to claim 1, wherein
the sensor housing has a sensor housing main body formed in a cylindrical shape,
the joint surface is inclined from one side to the other side in a direction in which a central axis of the sensor housing main body extends so as to approach the central axis,
the connector housing has a connector opening to which an external connector is attached and detached, and
a center position in a direction in which the central axis extends at the connector opening is offset to the other side in a direction in which the central axis extends with respect to a center position in the direction in which the central axis extends at the flange.

18. The sensor device according to claim 1, wherein
the sensor housing has a sensor housing main body formed in a cylindrical shape,
the joint surface is inclined from one side to the other side in a direction in which a central axis of the sensor housing main body extends so as to approach the central axis,
a distance along the direction in which the central axis extends between an outer wall of the connector housing on one side in the direction in which the central axis extends and an outer edge of the flange on one side in the direction in which the central axis extends is defined as A,
a distance along the direction in which the central axis extends between the outer wall of the connector housing on the other side in the direction in which the central axis extends and the outer edge of the flange on the other side in the direction in which the central axis extends is defined as B, and
a condition A>B is satisfied.
